(19) United States
(12) Patent Application Publication
(10) Pub. No.: US 2022/0381158 A1
(43) Pub. Date: Dec. 1, 2022

(54) Methods and apparatus for fast starting heat recovery steam generators for combined cycle power plants

(71) Applicant: Thomas Edward Duffy, San Diego, CA (US)

(72) Inventor: Thomas Edward Duffy, San Diego, CA (US)

(73) Assignee: Thomas Edward Duffy, San Diego, CA (US)

(21) Appl. No.: 17/300,366

(22) Filed: Jun. 1, 2021

(51) Int. Cl. F01K 13/02; F01K 23/10; F22B 1/18

(52) U.S. Cl. CPC F01K 13/02; F01K 23/108; F22B 1/1815

(57) ABSTRACT

A fast HRSG starting method and apparatus for combined cycles requiring frequent cycling, baseload and backup power; preventing grid failure from variables of wind and solar power. A once-through HRSG, eliminating all except two hot thick wall components: the high pressure superheater and reheater headers. The method fills the high pressure superheater with boilerwater; whereby steam is generated in starting as thick header's and tube's ramp-up together at saturation temperatures as the gas turbine attains synchronous speed No-Load; reducing conventional thermal stress failures loss of availability and costly repairs. At gas turbine full power dry steam is generated by the high pressure superheater at low allowable temperature start and load the steam turbine and protect the reheater. The dryout zone in the high pressure superheater is controlled loading the steam turbine faster than conventional without problematic attemperators, thereby decreasing: thermal stresses, fuel, emissions and possible ingestion of spray-water.

### BACKGROUND OF THE INVENTION

This invention relates generally to combined cycle power generating systems and more specifically, to methods and apparatus for fast starting and loading the heat recovery steam generators (HRSG) of such systems without the use of problematic attemperators and to minimize thermal stress damage to the HRSG superheater and reheater. Thousands of Combined Cycle (CC) power plants are operating throughout the world. In the first fifty years, most were installed as baseload and designed to load to full power in hours to accommodate thermal stress limits of thick wall steam components. The long starting time of these CCs required long gas turbine low power holds necessary to generate low allowable steam temperature from the HRSGs to prevent damaging thermal stress in thick walled components and damaging interferences in steam turbine rotating parts. Although this is a loss of flexibility; as well as increased emissions and fuel costs; it was tolerated since it was only planned for a few starts per year. Operating experience with these CCs demonstrated that even these hold-starting cycles caused most HRSG's component damage, requiring major repairs to many HRSGs; and reduced availability in after only a few hundred start cycles. Problems recorded with HRSGs starting include: superheater and reheater header cracking, tube-to-header weld connection failures, tube buckling, and steam drum cracks. This long history of cycling problems has reduced availability, lowers reliability and increases maintenance costs. Steam turbine components and drums are especially at risk, requiring generating controlled low temperature steam for a long time during starting to minimize thermal stress and maintain adequate clearances in starting, warm-up and loading. Increased installations of renewable solar and wind power often require daily or more frequent starting of critical CC power plants. These new cycling requirements plus: operational, economic and emissions requirements, necessitate loading the gas turbine to full power as fast as possible without a conventional part-load hold for long periods to provide a low exhaust temperature to accommodate steam components. Currently, gas turbines are required to accelerate to full power in 30 minutes or less after overnight shutdown in order to accommodate solar and wind power variability that can cause grid collapse. New once-through type HRSGs eliminate steam drum thermal stress problems and thereby allow the gas turbine to start up and load to full power in 30 minutes. In these HRSGs, high temperature steam generated is bypassed around the steam turbine until generated steam temperature is sufficiently reduced by relatively cool boilerwater sprayed from attemperators to supply the low temperature steam required to start the steam turbine. Current-state-of-the-art HRSGs are started after an overnight shutdown with the high pressure superheater filled with reduced temperature static saturated steam. The gas turbine is motored at start up for many minutes in a purge cycle, pumping cold air to clear possible fuel gas leakage; thereby thousands of pounds of condensate are accumulated in the superheater and reheater bottom headers and tubes. This condensate must be rapidly and completely drained to flash tanks to prevent carry forward when steam flow is initiated to prevent water quench damage to HRSG high temperature components. After flame detection, the exhaust gas rapidly increases in temperature to over 1,100° F. in less than 30 minutes as the gas turbine is rapidly accelerated and fully loaded as fast as possible without a power-temperature hold. Both the superheater and reheater finned thin-walled tubes, filled with stagnant saturated steam, rapidly heat to the exhaust gas temperature with a slight lag. Thereby, many minutes before steam flow is initiated from the evaporator, the superheater and reheater tube temperatures rapidly approach gas temperature hundreds of degrees above the thick-wall headers temperatures that remain cool for many minutes. This causes high differential temperatures and damaging thermal stresses in both conventional natural circulation drum and Benson once-through HRSGs. As a consequence, differential temperatures cause high header and tube joint stresses plus high tube buckling loads. Another problem is that complete draining has often proven to be difficult and partially drained condensate flows forward, quenching hot tubes and causing uneven cooling of tubes which also produces buckling damage due to tube-to-tube differential temperatures and tube joint-to-header cracking. Interstage attemperators are designed to solve these problems by spraying relatively cool boilerwater into the middle of the superheater and reheater to cool the steam and prevent overtemperature. Additionally, terminal attemperators spray low temperature boilerwater into the terminal discharge paths of the superheater and reheater to reduce the steam temperature to the allowable temperature required by the Steam Turbine Stress Controller as it controls starting the steam turbine. The effectiveness of attemperators is dependent on high velocity steam flow to assist in atomizing, mixing and evaporating the injected water mass flow spray which must be accurately controlled. For advanced rapid starting CCs, typically four attemperators using copious quantities of relatively cool boilerwater flow rates are required to generate the cooling steam flow to limit over-temperature damage of the superheater or reheater and to supply turbine starting steam at a much lower allowable steam temperature than the conventional HRSG generates with the gas turbine at full load. U.S. Pat. No. 7,621,133 METHODS AND APPARATUS FOR STARTING UP COMBINED CYCLE POWER SYSTEMS granted to one of the world's largest manufactures of steam turbines, describes the method it has installed in many CCs for rapidly accelerating to full power; whereby the steam produced with conventional HRSG superheater and reheater uses two terminal and two interstage attemperators in the HRSG to generate allowable low temperature steam at 700° F. in the patent example (or slightly above the steam turbine's measured bowl metal temperature when starting) to start the steam turbine. As described in U.S. Pat. No. 7,621,133, attemperators are now installed in fast start combined cycles to spray large quantities of relatively cool water into the high pressure superheater and reheater steam paths to generate 700° F. steam with the gas turbine maintained at full power. This temperature is necessary to control the steam turbine stresses and clearances in the starting for the many minutes while the gas turbine is maintained at Full Load power. Additionally, at low power demands to prevent many additional forced steam system shutdowns the attemperators are employed to cool the steam generated at low gas turbine power. At the low operating power, exhaust gas flow is reduced on many turbines and exhaust gas temperature increases, causing excessive tube metal to temperature. Attemperator water sprays prevent over temperature of tubes and thereby prevent many life reducing and expensive CC forced shut downs. The attemperators have a problematic operational history with reported damage including: over-spray water quench, and thermal differential damage of tube buckling and joint cracks in superheater and reheater HRSG components, resulting in high thermal stresses reducing life and over-spray steam turbine water ingestion damage.

Basic changes and innovative systems and methods have been introduced to obtain design solutions for these HRSG starting problems. The current changes concentrate on solving the thick wall drum stress problems, as well as the tube-to-thick wall header connection failures. High pressure drum, superheater and reheater header materials have been upgraded to higher strength alloys. Reduced diameter and reduced wall thickness drums described in recently patented systems use a two-stage method of steam separation. They use eight vertical secondary vertical steam separator bottles welded to the top of a reduced diameter high pressure drum made of higher strength steel and are operating in newly commissioned HRSGs. The additional eight separators are designed to eliminate boilerwater liquid spray and chemical carry-over from the confined spaces of the reduced diameter main horizontal drum. Another approach is to eliminate the high pressure drum entirely by using a patented once-through Benson forced flow evaporator circulating system; using high purity feedwater with low dissolved solids. The Benson design has two evaporator sections that use vertical heat transfer tubes with forced flow evaporation modified by natural circulation in vertical tubes to match the tube row heat flux. Between the first and final evaporator, a two-phase flow distributor is installed to produce a more uniform steam water mixture entering the final evaporator designed to produce superheated steam. Steam from the final Benson evaporator passes through a steam separator mounted externally of the HRSG casing. This separator is designed to ensure dry steam is conducted into the superheater sections of the HRSG in starting. The steam separator is normally employed during starts to separate swellwater and spray from the steam. During normal operation of this type HRSG, the separator is dry since the final evaporator is designed to produce superheated steam. Both of these HRSG configurations are specially designed to meet fast start specifications, but they result in extra complications, possible parallel flow boiling instability with additional steam pressure loss and expense. The superheater and reheaters are uncooled in both modifications during starting until the attemperators introduce cool boilerwater spray to protect the tubes. Another limitation of the Benson and reduced diameter drum HRSG start solutions is they both incorporate the relatively rigid thermal harp heat exchanger in their heat transfer modules. Thermal harps are fabricated in a factory into transportable modules and assembled as an HRSG on site, totaling thousands of approximately 50-to-80 feet tubes, with each tube end welded to thick headers at the top and bottom of each vertical tube. This relatively rigid structure has been generally acceptable for base load power plants. Fast start and cyclical service has required redesigns of thermal harps to reduce rigidity, particularly for the superheater and reheater. New cyclical service HRSGs are generally constructed with only one row of tubes per header connecting to critical hot headers to reduce header diameter, thickness and stress. One of the main reasons for the bottom headers is to drain water. Historically in starts, condensate quench failures of tubes, joints and headers have been traced to inadequate draining of bottom headers. The fast starting designed harps use three large pot drain valves per high temperature bottom headers to account for header thermal bow distortion. These drains are controlled automatically with large capacity water sensing drain pots or equivalent. With bundles redesigned for fast start, only one row of tubes per header is used per harp, whereby lower headers are free to expand downward, accommodating the average expansion of a single row of tubes to minimize damage. Although this does not eliminate tube-to-tube differential expansion or tube-to-thick header differential temperature stress, the single row header reduces the high calculated stresses due to differential temperatures between two or more tube rows connected to the same header.

The design fixes described above are incremental improvements to resolve specific drum, header-tube thermal stress and drain problems caused by conventional fast starting methods. However, the design fixes don't solve the many problems of: thick wall header-to-tube differential thermal stress and the means to control starting temperatures without problematic attemperators, and incomplete draining causing carryover quenching of hot tubes. A part of the solution to reduce thermal stress in starting is the once-through HRSG without drums and most headers. An exemplary HRSG of the once-through type with vertical tubes is described in U.S. Pat. No. 8,820,078 HEAT RECOVERY STEAM GENERATOR AND METHOD FOR FAST STARTING COMBINED CYCLES, which is incorporated herein by reference. This patented once-through configuration with vertical tubes is not in operation in large HRSGs at present. However, more than 200 once-through HRSGs with horizontal tubes are currently installed around the world. They have a patented once-through flow path. U.S. Pat. No. 4,989,405 COMBINED CYCLE POWER PLANT describes the flow path and basic configuration of the more than 200 once-through HRSGs are in operation. These HRSGs have a unique start method; they start completely dry, with feedwater introduced into the economizer header after flame detection. These operating HRSGs substantiate the patented basic once-through flow path of identical parallel serpentine circuits; wherein a feedwater flow rate controller regulates the HRSG output steam temperature by balancing output steam energy to the input energy of the exhaust gas. The feedwater flow rate controller uses measured gas turbine parameters and steam temperature feedback to correct for degradation in the gas turbine and the heat transfer factors. The feedwater is directed through an orifice in each economizer tube for uniform flow and to stabilize parallel flow boiling and controlled temperature steam discharges from the superheater. Their typical current application is less than 70 MW combined cycle power plants and are constructed using horizontal tubes that are self-draining. Large utility HRSGs (a main application disclosed herein) require approximately ten times larger heat transfer area compared to the 70 MW once-through HRSGs. Structural criteria, gas flow path and costs to mechanically support thousands of tons of sliding horizontal heat transfer tubes justify use of top-supported vertical pendent tube once-through HRSG configurations as an economic solution for large HRSGs. However, vertical tube once-through circuits are not drainable. U.S. Pat. No. 8,820,078 describes a simple pressurized air blowdown drain and drying system. This system only requires two valves to drain and dry the HRSG for maintenance, freeze protection or layup with vertical tubes. Whereby the numerous: pot drain valves, headers and complex drain pipes that reduce expansion flexibility required in conventional HRSGs are eliminated. Conventional gravity draining dozens of bottom headers (each with three drains, plus rigid piping) often results in reliability problems to completely drain and dry the conventional HRSGs. The simple two-drain-valve, dry air blowdown system results in fast and complete draining and air flow drying plus nitrogen blanketing. A simple two-valve nitrogen blanketing system is also described in U.S. Pat. No. 8,820,078 for long weekend shut downs using an automatic nitrogen blanketing system (such as nitrogen membrane generating systems) for corrosion protection when steam pressure falls below 5 psig.

The exemplary once-through HRSG flow path is fabricated entirely of tubes arranged in separate identical serpentine flow path circuits assembled in parallel circuits for each pressure level. U-tubes connect long vertical finned tubes at the top and bottom in a serpentine flow path without intermediate headers, completing an all tubular flow path between the inlet and outlet headers and forming a complete circuit. Starting at the economizer inlet header, water passes through a flow restrictor at the inlet of each circuit to distribute flow uniformly between circuits and prevent parallel channel boiling instabilities. From the economizer, water flow goes through a connecting tube to a tubular evaporator, discharging from it directly to the tubular superheater and its outlet header. The serpentine tubular flow path from the economizer header through to the superheater header is without headers in-between. Feedwater flows from the economizer header through the first inlet row tube and through the economizer through a single flow path to the last row of the superheater header. Different HRSG sections often incorporate various tube diameters and fin configurations for optimum design criteria. By assembling 20 or 30 circuits in parallel, a module is assembled to facilitate transportation. Several modules complete a once-through HRSG for CCs when supported and connected in the casing. Evaporation typically takes place approximately at the middle of each circuit in normal operation (without a drum or separator). Depending on operating conditions, the evaporation function can be located anyplace in the circuit to optimize performance (for example: optimization for extreme ambient air temperature or maximum efficiency at low power). Most of the HRSGs of the once-through type in operation start dry, without boilerwater in any of the tubes, and evaporation initiates in the first rows of the economizer during starting, providing cooling steam flow. In operating mode, the once-through HRSG utilizes a predictive control method to set the feedwater flow to the generated steam energy to match the input gas energy flow rate. In this control method described in U.S. Pat. No. 5,237,816 STEAM GENERATOR CONTROL SYSTEM, the thermal energy entering the once-through HRSG is calculated by the controller from the gas turbine's measured parameters at measured ambient air temperature and known turbine characteristics. The input gas energy to the HRSG predicts and sets the feedwater flow (and thereby the steam flow) to match the CC's known parameters to produce maximum steam power output at any power from part load through full power of the gas turbine. The water flow rate is set immediately and feedback flow is measured in a fast-response feedwater flow control loop. Concurrently, the slow-lagging measured output steam temperature and pressure are used as feedback to provide required trim corrections to the actual water flow rate to account for turbine degradation, heat exchanger fouling, leakage and other factors modifying the computer calculated predictive steam flow rate. This method of control has been proven to have high response in the operating once-through HRSGs and is installed on many smaller combined cycles that often require rapid transient response. Many once-through type HRSGs are installed with LM6000 gas turbines with a horizontal HRSG tube orientation supported by tube sheets. Tubes in most installed once-through HRSGs are made of alloy Incoloy 800: a high nickel (˜30%) and high chromium (˜20%) high temperature and corrosion resistant tube (the fins are typically carbon steel). This expensive alloy is competitive in small HRSGs for many reasons, including: dry operation at full gas turbine power, dry starting, self-draining, corrosion protection and simple water treatment. In small HRSGs, material costs are a relatively lower fraction of the total installed cost. Large utility HRSGs require approximately ten times the tubing of the small once-through type HRSGs. For large utility CCs as disclosed herein, the expensive alloy cost is not economic or necessary for large CC operating specifications. Operating experience with Benson type once-through HRSGs substantiates the use of “standard carbon steel tubes” when operating with full flow condensate polishing and all volatile water treatment for large utility type HRSGs.

The mechanical design problem of supporting hundreds of tons of horizontal finned tubes (as they expand and slide across many expensive thick tube sheets) needs a different solution: a top supported vertical tube arrangement. Top supported vertical tubes, where the massive weight is carried by flexible hanger rods in tension for each circuit for maximum flexibility, is well matched for large HRSGs. One innovative arrangement is described in U.S. Pat. No. 6,019,070 CIRCUIT ASSEMBLY FOR ONCE-THROUGH STEAM GENERATORS. It describes an innovative mechanical configuration for a large vertical tube once-through HRSG fabricated with “carbon steel” tubes (tubes of standard ASME carbon and low alloy steel tube specifications used in conventional HRSGs). The long vertical finned heat transfer tubes are arranged in a continuous serpentine flow path, with the tubes connected by U-bends or longer jumper tubes to form a series of modules each with matching individual circuits. Typically, each tube end is connected to a tubular U-bend connected to the next tube row with a computer controlled orbital welding machine to the vertical finned tubes in a factory for quality control. Rigid thickwall headers are not used in order to provide maximum flexibility between tubes and circuits. The tubular circuits in parallel are welded to an inlet economizer header and form an economizer module, and jumper tubes are connected in the field erection to evaporator modules; jumper tubes in turn connect the outlet of the evaporator to the superheater bundle circuit modules connected to the superheater outlet header to form a multi-module complete once-through HRSG. Full-flow condensate polished deionized (DI) feedwater is required, combined with all volatile pH control with deaeration; as used in many operating Benson once-through HRSGs, and similar water treatment is used in many large supercritical steam power plants installed around the world. The latest developments in RO, membrane oxygen control and membrane carbon dioxide control also are well matched to the frequent starting CCs to minimize boilerwater chemical upsets in fast cycling units.

### BRIEF SUMMARY OF INVENTION

In one aspect, a method for fast starting the HRSG of a combined cycle (CC) power generation system is provided to reduce thermal stresses in the HRSG high pressure superheater and reheater; and generate low temperature steam to start the steam turbine without attemperators. The method includes loading the gas turbine at a maximum rate, and maintaining the temperature of the high pressure and hot reheat steam supplied to the steam turbine at the substantially constant lower allowable starting temperature of 700° F. (in this example) from initial steam admission into the steam turbine until all the steam generated by the HRSG is admitted; which enables optimum loading of the steam turbine to criteria from the Steam Turbine Stress Controller; and at the same time protecting the high pressure superheater and reheater components from overheating and thermal stress damage.

In another aspect, a system for starting and loading a CC power generation system is provided. The system includes a gas turbine and a steam turbine. The CC system further includes a once-through HRSG which supplies steam to the steam turbine, a condenser connected to the steam turbine, and bypass paths used in starting from the HRSG around the high pressure steam turbine section to the cold reheat steam line. In addition, the flow path through the reheater into the intermediate pressure manifold which has a bypass around the intermediate steam turbine to the condenser used in starting. The intermediate pressure manifold also has a flow path to a normal admission valve to the intermediate steam turbine used for normal CC operation. Further, a second admission bypass start-up admission valve around the high pressure steam turbine section conducts HRSG high pressure steam directly to the intermediate pressure steam turbine section. Also, the method utilizes a once-through HRSG equipped with a unique HRSG start-up apparatus and circuit drain system to enable a wet starting method to produce steam faster than conventional systems while also reducing damaging thermal stresses. The HRSG start-up apparatus accurately positions boilerwater level in the top of each last row superheater tubes. The wet starting method is initiated with the superheater last row tubes filled with saturated boilerwater. Whereby as the gas turbine accelerates and is loaded to Full Speed No Load and Full Speed Full Load at a maximum rate, the wet starting method controls the dryout zone in the superheater by a start-up boilerwater level controller. In this method the high pressure superheater generates a gradual ramp-up in steam temperature from saturation temperature to dry steam at an allowable superheat temperature for starting the steam turbine at 700° F. Whereby the HRSG tubes do not overheat and differential thermal stress between header to tubes is minimized. Conventional steam temperature control by attemperators spraying relatively cool boilerwater into hot components is eliminated; thereby reducing thermal cycling damage while reducing possible steam turbine water ingestion. The method includes loading the gas turbine to full load at its fastest rate, maintaining the temperature of steam to high pressure and intermediate pressure sections of the steam turbine at substantially constant low superheated steam temperature (700° F.) from the initial steam admission to the steam turbine until all of the steam generated by the HRSG is admitted, while modulating flow of steam through the bypass paths so as to control the high pressure and intermediate steam pressure. After all steam flow is admitted to the steam turbine at a low starting temperature, the steam temperature to the high pressure section and intermediate steam turbine section is increased to full rated load steam turbine temperature and flow by adjusting the dryout zone position through the superheater and into the evaporator until the dryout zone is in its normal position in the evaporator. The temperature increase rate is controlled by the HRSG feedwater flow controller to adjust steam temperature rise rates to the setpoint criteria from the Steam Turbine Stress Controller element of the steam turbine. This method is also employed to prevent over-temperature of tubes at low load CC operation to cool high temperature steam, replacing problematic attemperators.

### DESCRIPTION OF DRAWINGS

FIG. 1 schematically illustrates a HRSG in a CC system with a once-through type high pressure steam generator 25, showing a start-up apparatus 1 connected to the high pressure superheater header 14 discharge nozzles 9 of the HRSG and a circuit drain system including drain tubes 13 in each tube circuit at the economizer inlet first tube row 5 that are used in the starting method described. A key element in the starting system is the location of the last rows of the reheater 3 immediately downstream of the final rows of the high pressure superheater in the exhaust gas path. Also illustrated is the arrangement of steam turbine admission valves 46, 47, 48 and 49, including an innovative addition of an intermediate pressure steam turbine IP start-up admission valve 49; used as an element of the starting method to bypass the high pressure steam turbine HP in starting.

FIG. 2 is an arrangement of the start-up apparatus 1 piping system above the HRSG casing 19 at the last superheater discharge row with steam flowing upwards to the superheater headers 14 within the casing. The gas turbine exhaust gas is depicted flowing horizontality from left to right into the last row of the vertical tube high pressure superheater tubes 2. This is a side view of the start-up apparatus 1 and illustrates the relative geometric height position of the apparatus pipes and level sensors (LE) 21 relative to the last row 2 of the high pressure superheater tubes which is a key element employing gravity-draining forces used in placing the HRSG in a “ready to start status” with the last row of tubes 2 filled with boilerwater prior to starting; and whereby in starting, as the gas turbine starts to accelerate; concurrently the circuit drain system lowers the level of the boilerwater position into the superheater last rows of tubes 2 as the gas turbine accelerates to Full Speed No Load.

FIG. 3 is an arrangement of the start-up apparatus looking in the direction of the gas turbine exhaust flow into the last row 2 of the high pressure superheater, from a position ahead of the high pressure superheater. It is labeled “view A-A” in FIG. 2. Two superheater headers are illustrated, but three or more headers are commonly installed for shipping or erection criteria. Also illustrated are the main components of the start-up apparatus: the horizontal drain manifold 8, boilerwater level sensor 21, and pot drain systems: 20, 22 and two 23 LE redundant level sensors installed on each pot drain 20 at each end of the horizontal drain manifold 8. The water level sensor 21 LE for positioning the height of water in the water barrier loop or dam of the horizontal drain manifold 8. The start-up pressure control valve 12 is shown at the bottom of a long drain line with water level sensor LE 24 and a small metering valve 33 bypassing the large pressure control valve 12.

FIG. 4 is a top view of the start-up apparatus 1 installed above the top of the HRSG casing. It illustrates the connection between the horizontal drain manifold 8 to the superheater header nozzles 9 that connects steam from the high pressure superheater headers to the start-up apparatus 1.

FIG. 5 is a schematic of the high pressure superheater start-up boilerwater level controller 100.

FIG. 6 is a schematic of the high pressure steam generator feedwater flow rate controller 88.

### DETAILED DESCRIPTION OF THE INVENTION

While the starting methods and apparatus described herein are in the context of a combined cycle used in an electric utility power generation environment, it is contemplated that the method, apparatus, teachings and principles described herein may find utility in other applications such as: cogeneration, industrial HRSGs, and gas turbines using a variety of combustible fuels, including but not limited to natural gas, liquid fuels and green hydrogen. In addition, such starting methods can be utilized in connection with both multi-shaft and single-shaft combined cycle systems. Multiple reheaters and supercritical pressure HRSGs are also well accorded the benefits derived from the described apparatus and methods. The description herein below is therefore set forth only by way of illustration, rather than limitation.

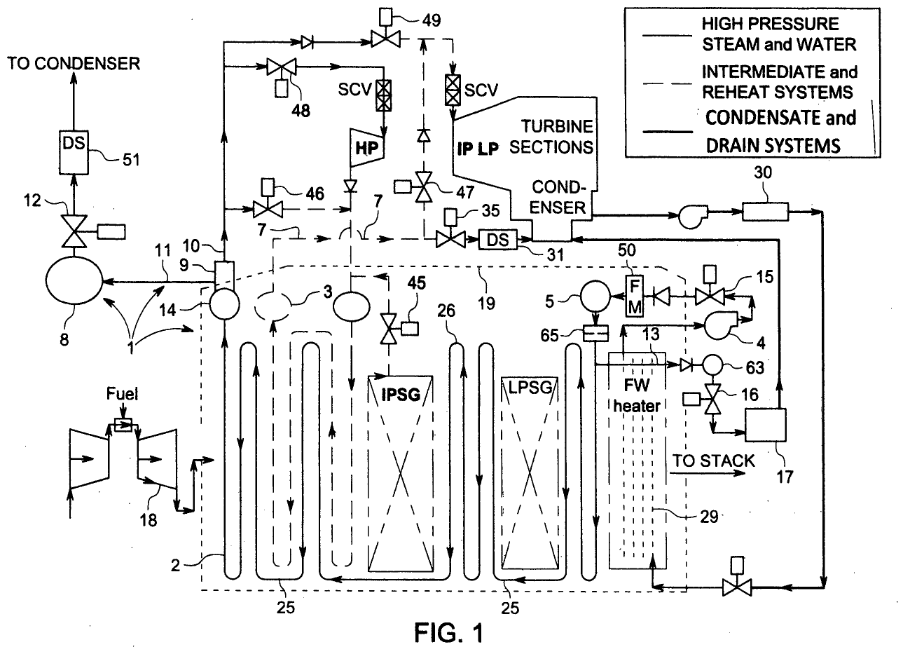

FIG. 1 is a schematic illustration of a combined cycle power system in accordance with one embodiment of the present invention. As is known in the art, the CC system includes a gas turbine system 18 comprising: a compressor, a combustor fuel system and a turbine section that typically drives an electric generator (not shown). In a single-shaft system (not shown) the steam turbine would drive the same generator as the gas turbine system 18. Exhaust gases discharging from the gas turbine, which may include supplementary firing, enter the HRSG 25 ducting and flow through housing 19. The HRSG generates steam at three pressure levels in this illustration to drive the HP high pressure, IP intermediate pressure and LP low pressure steam turbine sections for a three pressure steam power system to drive a generator (not shown). The HRSG is fabricated using vertical “conventional carbon steel finned tubes” or of any other Boiler Code approved metal alloys matching superheater and reheater temperatures. It is a once-through high pressure steam generator flow configuration without steam drums and intermediate lower and upper headers, excepting headers for: inlet feedwater 5, outlet discharge superheated steam 14, and hot reheater header 3. Also illustrated is a unique circuit drain system: consisting of circuit drain tube 13, each tube 13 containing a one-way valve connecting drain flow from each first row economizer tube 5 in each circuit to circuit drain headers 63 and a single HRSG circuit drain valve 16 configured so it drains all circuits simultaneously of the entire HRSG high pressure circuits, thereby extracting pressurized boilerwater water from the hydraulically coupled last row of the high pressure superheater tubes 2 by opening circuit drain valve 16 closely coupled to each inlet economizer tube header 5. In operation, steam is produced in the HRSG 25 at three pressure levels illustrated with solid lines for high pressure and dash lines for intermediate pressure (low pressure not shown) and is conducted to the steam turbine systems to produce work in the high pressure HP steam turbine and mechanically attached to the intermediate IP and LP turbine sections to drive a generator (not shown). Steam exhausted from the HP turbine at intermediate pressure flows through a one-way valve to the reheater cold header and through to discharge hot header 3. Steam from the intermediate pressure steam generator IPSG flows from the intermediate pressure IP discharge valve 45 and also flows through the cold reheater header and discharges through hot reheater header 3. Steam flow to the IP turbine in normal operation comes from the reheater 3 that discharges into intermediate pressure manifold 7 from which it is connected by intermediate pressure turbine admission valve 47 into the IP turbine and then flows into low pressure LP steam turbine which also receives the low pressure steam from generator LPSG for expansion to the vacuum in the CONDENSER. Condensate, illustrated by heavy solid lines from the condenser hotwell, is pumped by the condensate pump to the feedwater treatment system 30 completing the Rankine Cycle flow path in FIG. 1. Only the high pressure steam circuit's serpentine flow path is illustrated together with the intermediate pressure reheat circuits described in detail to illustrate the main benefits of the invention. The two other steam generators: the low pressure steam generator (LPSG) and the intermediate pressure (IPSG) are shown in phantom outlines in approximate relative positions in the gas flow path through the HRSG. The feedwater preheater 29 is also used in many HRSGs (and is shown in thin vertical dash lines labeled (FW heater) to heat feedwater before entering the HRSG. The two lower pressure steam generators typically have heat transfer sections interspersed throughout the high pressure steam generator 25 which are not described to help appreciate the invention arrangement. The high pressure circuits of HRSG are illustrated by solid lines and reheater at intermediate pressure in dash lines. In FIG. 1 the reheat-intermediate pressure steam flow is illustrated with dash path 7. Condensate water starting in the deaerating vacuum CONDENSER hotwell as deaerated condensate is conducted to the condensate pump and then through a full flow condensate polishing system 30 including: filters, full flow polishing deionizing system, pH, oxygen and carbon dioxide control systems, and all volatile chemical treatment to produce feedwater suitable for a once-through steam generator with carbon steel tubes (condensate and drain flow paths are shown as thick solid lines). From the condensate water treatment system 30 the feedwater is pumped through the FW heater 29 and conducted to: the high pressure feedwater pump 4 powered by a variable frequency drive VFD motor, a feedwater flow control valve 15 for starting (and trim feedwater flow control), flowmeter FM 50 and into the economizer feedwater header 5. From the economizer header 5, the feedwater is distributed uniformly by flow restrictors 65 in each economizer inlet tube that provide circuit-to-circuit boiling stability at the inlet of each identical parallel circuit of the steam generator. In accordance with and embodying principles of the present invention, at least the high pressure section of the HRSG is a once-through type steam generator. Each circuit is identical in flow path, constructed with an all finned tubular serpentine flow path of feedwater into the economizer header 5 and conducted through to the evaporator 26, then as high pressure steam through the first superheater, and then conducted by jumper tubes across the reheater section into the final superheater section exiting in the last rows of the final superheater 2 connected to superheater headers 14. Tubular flow path is constructed of various tube diameters, wall thicknesses and code-approved alloys suitable to the temperature and stresses they are required to sustain in operation. The last row of the superheater tubes 2 are positioned at the gas turbine 18 exhaust gas entrance into the once-through circuits where turbine exhaust gas enters the HRSG casing 19 (illustrated with thin dash lines). This places the last high pressure superheater rows 2 in the highest gas temperature. The final reheat row section hot header 3 is arranged downstream of the final high pressure superheater 2 whereby the gas entering it is cooled by the final rows of the last rows of the final superheater section. The steam temperature from the high pressure superheater header 14 is regulated by feedwater flow rate controller 88 calculating feedwater flow rate to control feedwater valve 15 and feedwater pump 4 VFD motor. In starting; the high pressure steam temperature setpoints sent to controller 88 are provided by the Steam Turbine Stress Controller (STSC), an element of the steam turbine, for the steam temperatures necessary for safely starting the steam turbine. The Steam Turbine Stress Controller measures turbine metal temperatures, speed and other parameters to establish the setpoint steam temperatures for starting and loading of the steam turbine while the gas turbine 18 is operated at full load. The location of the final superheater 2 and the hot discharge reheater row 3 constitute the best embodiment of this invention; whereby the heat transfer surfaces are arranged to safely facilitate control of steam turbine warming. And by this arrangement, the final superheater rows reduce the gas turbine exhaust flow entering the reheater, other sections as arranged in FIG. 1 may be located in different positions within the high pressure circuit to optimize performance for specific gas turbines or other reasons and are not essential to the benefits described by the invention. One or more high pressure superheater sections may be located farther downstream in the gas flow path and dispersed with other lower pressure heat transfer sections to maximize performance. Other sections such as double reheaters, catalytic converters, and maintenance spaces between heat exchange sections may also be arranged within the steam generator of the HRSG. The number of vertical heat transfer tube rows shown in the once-through flow path 25 are to illustrate the concept but many more rows are used in practice.

In normal rated power CC operation, superheated steam is conducted from the high pressure superheater header 14 through the header discharge nozzle 9 to the high pressure steam manifold 10 and then through the main steam piping system to the high pressure steam turbine admission valve 48 of the high pressure steam turbine HP. After extracting work in the high pressure turbine, lower temperature and pressure steam is discharged through a one-way valve and mixed with steam from the intermediate pressure steam generator (IPSG) discharge valve 45. Both steam flows enter the cold reheater headers and flow through heat transfer tube rows illustrated in dash line paths to be discharged into the hot reheater header 3. From the hot reheater header 3 steam is conducted into intermediate pressure manifold 7 conducting the steam to the normal intermediate turbine admission valve 47. Other steam turbine valves are elements supplied as part of the steam turbine manufacturer and are illustrated by steam valve arrangement SCV (STOP-AND-CONTROL VALVES) that includes the trip-stop and control valves. These valves are manipulated in starting by the Steam Turbine Stress Controller (STSC) for: steam flow, temperature and pressure control; and to control steam turbine casing and rotor metal temperature differential change rates, as well as rotor speed, and transmit starting steam setpoint temperature inputs to the feedwater flow rate controller 88 to regulate the steam temperature in the starting method.

To better illustrate the unique high pressure system's starting method for a HRSG with at least the high pressure system configurated with a once-through flow path; the low pressure system and intermediate pressure HRSG system's starting methods are not described in detail since they can be started with conventional methods. Standard safety valves, drains, vents gages and other standard steam components are not shown to clarify the invention.

The start-up apparatus 1 enables a wet starting method in which the high pressure superheater is filled with warm boilerwater is at a saturation pressure of at least 35 psig; whereby the superheater and reheater do not overheat as in starting conventional HRSGs with dry stagnant steam in the high pressure superheaters. The start-up apparatus ensures each last row superheater tubes starts equally filled with the same volume of boilerwater; and as the gas turbine starts to accelerate, the water level in the tubes is controlled as tubes gradually ramp-up from saturated boilerwater temperature to generate low temperature dry steam required for starting the steam turbine while the gas turbine is at full power with turbine exhaust greater than 1100° F. for many minutes.

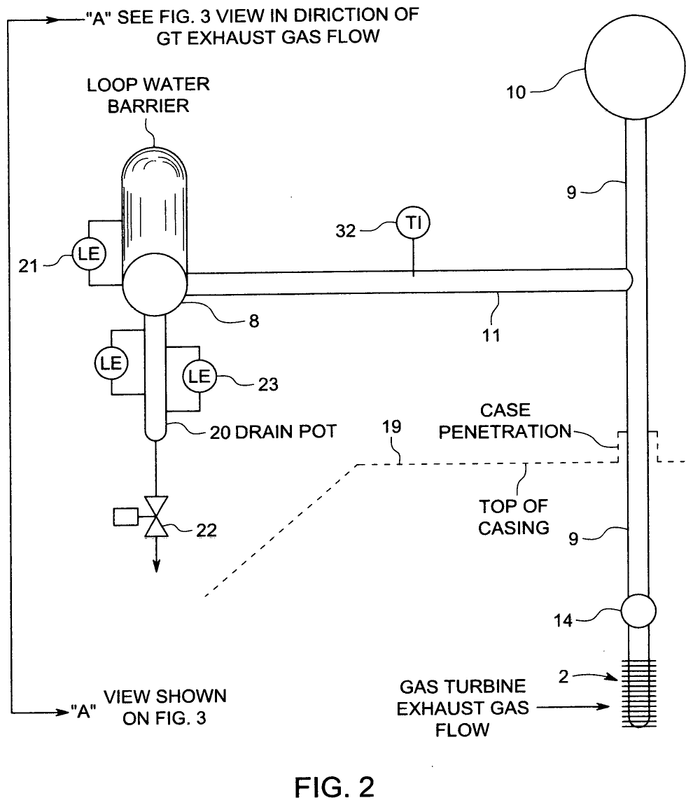

The start-up apparatus 1 is primarily a horizontal arrangement of pipes that provides a means to control the boilerwater levels when starting in combination with the unique circuit drain system components 13, 63 and 16. The apparatus also provides surge expansion volume attached closely to each superheater header for swellwater management in the starting method. The start-up apparatus 1 is fabricated of relatively small diameter pipes compared to the main steam manifold 10, these pipes providing a means to place the HRSG in a “ready to start status,” and thereby enabling: filling and controlling the water level in the high pressure superheater last tube rows 2, managing starting surge, draining swellwater and controlling temperature and pressure in starting. The start-up apparatus 1 is illustrated in FIGS. 1, 2, 3 and 4 as a pipe weldment of high pressure ASME Section 1 Boiler Code pipes. The plane of the paper in FIG. 2 is parallel to the plane of gas turbine exhaust flowing horizontally from left to right, illustrating the high pressure superheated last row 2 tubes where the gas enters the HRSG 25. The illustrations show an arrangement of the apparatus piping system on top of the HRSG 25 external to the casing 19 at the last superheater row 2. Steam flows upwards from the last row 2 to the superheater headers 14 within the casing 19 (shown as thin dash lines) with the horizontal flow of the gas turbine exhaust flowing across the last high pressure superheater tubes row 2. There is normally one penetration seal installed on the casing 19 for each header nozzle 9 as a normal part of the conventional HRSG arrangement. Since the start-up apparatus 1 is external to the casing 19, mounted on the top of the HRSG, additional case penetrations are not required for the horizontal drain lines 11 which are external of the casing 19.

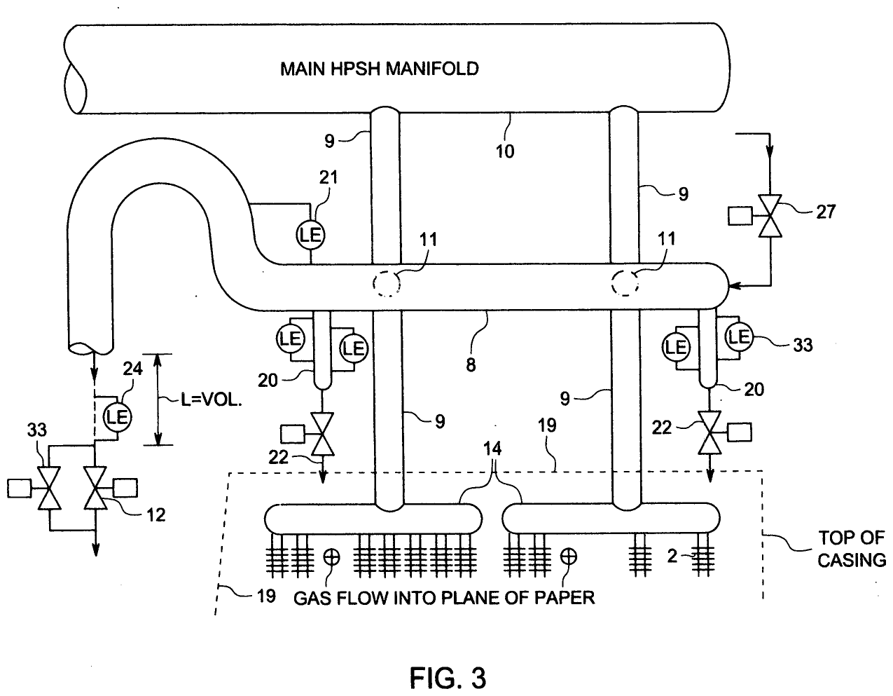

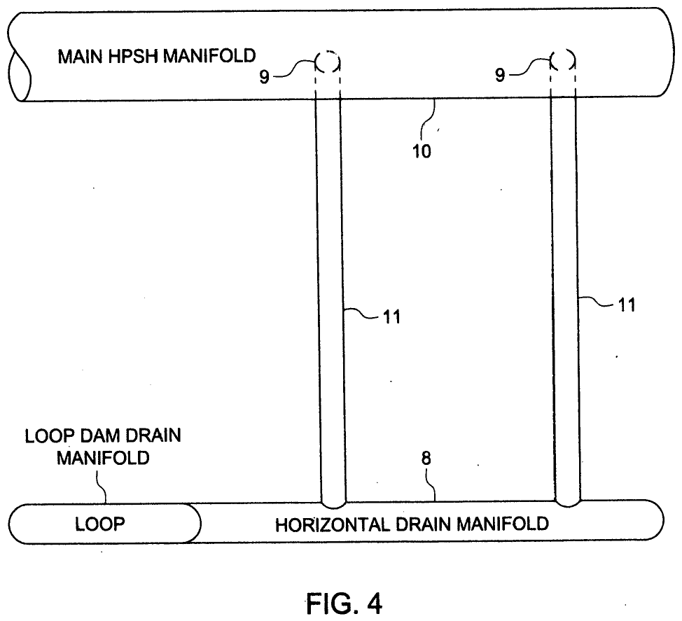

The last rows of the high pressure superheater tubes 2 are shown in the lower right corner of FIG. 2. FIG. 3 is an arrangement of the start-up apparatus 1 looking from the gas turbine in the same direction as the turbine exhaust flow into the vertical tube HRSG from a position just ahead of the high pressure superheater (shown as view A-A in FIG. 2). FIG. 3 illustrates the vertical steam drain line L conducting steam down from the loop barrier of the horizontal drain manifold 8 to the pressure control valve 12 at ground level (L distance to ground adds to surge volume). A small drain bypass metering valve 33 actuated by level indicator (LE) 24 drains any condensate accumulation around pressure control valve 12 in operation due to heat loss from the pipe L and is also employed in the hot starting method. From valve 12 the steam discharge from the start-up apparatus 1 is directed through desuperheater 51 to the CONDENSER (FIG. 1). The start-up apparatus 1 is configured without an obstruction, expansion, contraction or turn in the normal steam operating flow path from headers 14 to the main steam manifold 10. As a result, start-up apparatus 1 does not cause an additional pressure flow loss in normal CC power production. FIG. 4 is a top view looking down, showing the geometric horizontal plane relationship between the nozzles 9 of each header 14 and the horizontal drain manifold 8 to provide swell expansion volume and swellwater drainage closely coupled to each header nozzle 9. Two header nozzles 9 are shown for illustration but typically two or three nozzles per header are employed per superheater header 14 and two or three headers would be used in large HRSGs in an identical arrangement.

A warm starting method is described in detail in the next paragraph. Cold and hot starts are similar, with minor differences described in following paragraphs. In each starting method, the HRSG is placed in a: “ready to start status.” The HRSG after shutdown is bottled up to maintain as high a warm starting temperature as possible in preparation for a fast starting method to minimize thermal shock and minimize starting time. In warm starts, typically after an overnight shutdown, the superheater 2 contains stagnant saturated steam at a few hundred degrees F. after spin-down cooling and hours of HRSG heat loss plus cooling from motoring the gas turbine to purge possible explosive gasses from the HRSG. The saturated boilerwater is primarily located in the evaporator circuits 26 and is below normal operating temperature but typically more than a hundred psig when starting warm. Prior to starting, condensate from the condenser hotwell or feedwater makeup tank is pumped through the feedwater treatment system 30 and is pumped through the feedwater heater FW to feedwater pump 4 and through the feedwater control valve 15 to economizer inlet header 5. Whereby feedwater is distributed uniformly into each circuit by inlet restriction 65 at each circuit's first row economizer tube's inlet. The feedwater flow into the individual once-through circuit displaces boilerwater from each economizer circuit tube directly into the corresponding tube in the evaporator 26 section of the circuit of the continuous serpentine flow path; boilerwater flow in turn then displaces the saturated water in the evaporator section; forcing flow into the superheater tubes and filling them through the last superheater row 2 tube in each circuit. Boilerwater flow is continued through each last row 2 until all the superheater headers 14 are filled with saturated boilerwater from the evaporator 26 tubes. Pumped boilerwater flow sequentially is continued from the superheater header 14 and into the start-up apparatus 1 being pumped vertically through the header discharge nozzle 9 through the horizontal drain pipes 11 discharging into and filling the horizontal drain manifold 8, wherein the two pot drain valve systems 20 at each end of the horizontal drain manifold 8 are signaled to remain shut and thereby prevent evacuating the water during the filling procedure. The horizontal drain manifold 8 fills with saturated boilerwater until level sensor element (LE) 21 signals the feedwater control valve 15 to close. Thereby placing the water in the upward vertical loop section of the horizontal drain manifold 8 (FIGS. 2 and 3). Steam pressure during filling of manifold 8 is regulated by the start-up apparatus 1 pressure control valve 12 to limit steam pressure to less than 80% of rated operating pressure. The position of (LE) 21 is located below the main steam manifold 10 to prevent boilerwater from contacting the main steam manifold (see FIG. 3). The geometric vertical height level of the horizontal drain manifold 8 above the headers 14 ensures that if one or more circuits were slow to fill when pumping water through economizer header 5, they would become completely filled by gravity backflow of water draining from the horizontal drain manifold 8, flowing back-down through nozzles 9 into each header 14, and thereby filling and venting each last row of tubes 2, headers 14 and the lower part of nozzles 9. Next, prior to starting, a signal is transmitted to activate pot drain valve systems 20 to operate in their normal drain mode; and thereby their redundant sensors 23 detecting water, open pot drain valves 22, and thereby draining the water level from LE (21) to the bottom of the horizontal drain manifold 8. The pot drain systems; automatic level sensors 23 detect when water is no longer sensed in pots 20, and close pot drain valves 22 to prevent loss of steam pressure. The superheater headers 14 and their nozzles 9 are thereby left full of saturated boilerwater at the same level where horizontal drain pipe 11 is welded to nozzle 9, approximately three feet above the high pressure superheater header 14 in nozzles 9. Thereby a known specific volume of water now occupies the internal volume of the lower part of header discharge nozzles 9 starting at the intersection to horizontal drain pipe 11, plus the headers 14 and the volume of the tubes in row 2 and the next upstream row in the high pressure superheater. This places the start-up apparatus in a: “ready to start up” status. In this condition, starting can be initiated at any time.

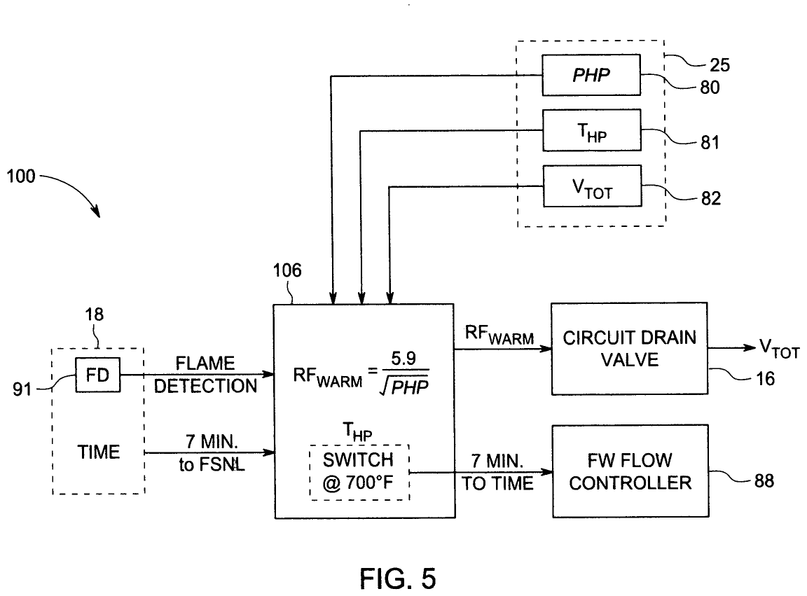

The starting method for the warm HRSG is initiated by the gas turbine flame detection signal 91 FD that is transmitted to start-up boilerwater level controller 100 (FIG. 5) and concurrently this signal transmitted to controller 100 opens circuit drain valve 16 for the time period (ti) after flame detection that the gas turbine takes to accelerate at a maximum rate to Full Speed No Load (FSNL), whereby the exhaust gas temperature rapidly rises in a few minutes to FSNL temperature. Thereby, saturated steam pressure in the start apparatus forces saturated boilerwater water level from the headers 14 “ready to start status” in the header nozzles 9 through each serpentine circuit's last row of superheater tubes 2 in each of the serpentine circuits; whereby hydraulically coupled boilerwater is thereby forced by saturation steam pressure through each circuit's first row economizer tube into drain header 63 removing a specific volume of boilerwater from each circuit. The water in each circuit flows through a circuit drain tube 13 welded to each circuit's first row economizer tube below the economizer header 5, located immediately downstream of the flow stabilizing restrictions 65 in each economizer inlet tube. The circuit drain tube 13 conducts the water in each circuit through a one-way valve installed in each drain tube 13 to a circuit drain header 63. In the starting method; the one-way valve in circuit drain tube 13 prevents possible steam back-flow from circuits with the highest heating rates to other circuits at the lowest rates since the exhaust gas at low gas turbine speed may not be as uniform as at full speed. In normal CC operation, the one-way valve in each drain tube 13 also prevents possible back-flow through the drain header 63 between circuits, bypassing some of the flow stabilizing effects of the inlet restriction 65. The drain headers 63 nozzles are connected through the circuit's drain control valve 16 to a flash tank 17. The flow differential pressure between header 14 and 63 is uniformly the same across each circuit's headers to assist in balancing the drain flow equally in each circuit.

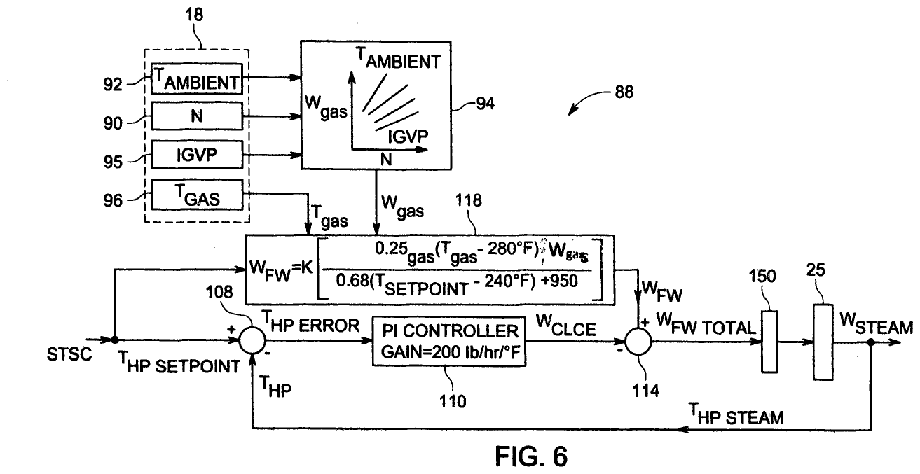

The starting method is to maintain the last tube row 2 and header 14 at approximately boilerwater saturation temperature during the initial acceleration of the gas turbine to reduce thermal stresses and generate dry steam earlier than conventional HRSGs. Thereby preventing the damaging differential temperatures between the thin tubes that rapidly go to gas temperature and the temperature lagging colder thick headers in conventional HRSG dry starts. Acceleration time to Full Speed No Load is typically 7 minutes as referenced in the background and is used in this description. The circuit drain valve 16 flow rate coefficient Cᵥ is selected to enable draining the final two rows of the high pressure superheater in 7 minutes of the volume of water in tubes V_{TOT} (the two rows where the exhaust gas enters the HRSG). The lowest drain forcing pressure in a cold HRSG is used to select drain valve 16 flow rate coefficient. When cold, a corrosion protecting nitrogen blanket at a pressure of at least 5 psig is applied by nitrogen supply valve 27, see FIG. 3, to the HRSG steam containing spaces to prevent corrosion. When placed into fast starting service, if the HRSG saturation steam pressure cools to less than 35 psig, the nitrogen pressure is increased to maintain at least 35 psig for motive starting pressure and keeps start-up apparatus in: “ready to start status” for a cold start. Therefore 35 psig nitrogen is the lowest drain motive pressure for cold starting and valve 16 flow rate coefficient of Cᵥ is selected for this pressure to drain a volume that includes the last row 2 plus the next row upstream in seven minutes. The number of rows drained depends on the specific configuration of the superheater tube bundle. The flow ratio FR of valve 16 is assigned as 100 Flow Ratio when fully opened with 35 psid motive drain pressure when cold. Valve 16 FR open position is decreased to drain the same volume of boilerwater at the higher saturated steam pressure when starting warm. Start-up boilerwater level controller 100 calculates the flow ratio opening for valve 16 to adjust its flow ratio FR to a lower setting adjusted to the actual higher motive saturation pressures when starting warm or hot. Thereby the calculated boilerwater level is positioned into the top of the second row of tubes farther upstream from superheater header 14 for all measured starting pressures. This is a calculated position dependent on the gas turbine and the superheater design arrangement to keep row 2 at approximately saturation temperature when starting. A second controller, the feedwater flow rate controller 88 (see FIG. 6) is signaled to control the superheated discharge temperature at T_{HP} set point of 700° F. (from above background discussion of the GE patent) after circuit drain valve 16 is closed.

The volume of boilerwater 82, V_{TOT} see FIG. 5 to be drained from HRSG 25 in the first 7 minutes of the starting method is to be equal to the total volume: in row 2 and the next row upstream plus additional volumes: the bottom half of nozzles 9 and headers 14 (see FIG. 2 and FIG. 3). Start-up boilerwater level controller 100 calculator block 106 adjusts the circuit drain valve 16 flow ratio (FR) to a computed partially open position of circuit drain valve 16 to adjust the flow rate to drain the same V_{TOT} removed from the high pressure circuits for the actual starting saturated steam pressure PHP 80 in the high pressure superheater. Thereby when the gas turbine accelerates to Full Speed No Load, controller 100 modulates the flow ratio FR command to drain valve 16 as a square root function of the motive drain pressure ratio between the cold starting at 35 psig nitrogen (where the drain valve=100 FR) to the higher saturated steam pressure in warm starting where valve 16 is set at a lower flow ratio. The pressure differential across valve 16 is approximately equal to the measured gauge pressure PHP 80 of the high pressure superheater; since pressure downstream of drain valve 16 is approximately one atmosphere in flash tank 17 and the mainly liquid filled circuit's flow losses are relatively low and can be neglected. The flow ratio, (FR) for valve 16 is set by calculation block 106 of the start-up boilerwater level controller by:

V_{TOT}=t·Cᵥ·(FR_{warm})(PHP)^{1/2} (1)

V_{TOT}=t·Cᵥ·(FR_{cold})(P_{nitrogen})^{1/2} (2)
Where:
PHP=the measured saturation pressure in the high pressure superheater when starting warm or hot,
P_{nitrogen}=35 psig nitrogen pressure in apparatus when HRSG is cold,
Cᵥ=the flow coefficient of drain valve 16 in gallons per minute at a water ΔP of 35 psid and where FR_{cold}=100.
Substituting: 35 psig for P_{nitrogen}, and t=7 minutes, and dividing out the constants:

$$FRwarm = 100 \times \frac{\sqrt{35}}{\sqrt{PHP}} = 100 \times \frac{5.9}{\sqrt{PHP}} \qquad ( 3 )$$

At flame detection 91 FD, boiler water level controller 100 opens circuit drain valve 16 and its flow ratio rate FR_{WARM} is adjusted by the measured steam pressure 80 PHP in the HRSG 25 superheater as the gas turbine starts to accelerate to Full Speed No Load. Thereby as the rotor speed, gas temperature and exhaust gas flow rate are increasing, the boilerwater dryout zone simultaneously retreats through drain valve 16 from the high pressure superheater header 14 toward the bottom of row 2. In this process; boiling swellwater wets and initially maintains both the headers and tubes at saturated boilerwater temperature, and as the exhaust gas temperature and flow rapidly continues to increase; steam flow is generated through the last superheater row 2 and flows into start-up apparatus 1. Pressure is controlled by control valve 12 that gradually ramps the initial pressure to a higher saturation pressure, to minimize thermal stress between the thick header and thin tubes. As steam and swellwater are discharged through the header (heating it), and the tubes are cooled to swellwater temperature in the initial starting transients at the critical header joint. Concurrently, swellwater in the dryout zone of tubes is drained away from the superheater headers 14 toward evaporator section 26 of the HRSG as swellwater and heated boilerwater is conducted into upstream superheater tubes and vaporizer tubes by means of boilerwater backflow through circuit drain valve 16. Concurrently, wet steam and carryover swellwater are also discharged from the header 14 into start-up apparatus 1 heating header 14 while cooling tubes in row 2. Carryover swellwater mainly collects in the horizontal drain manifold 8 and as the pot drain valve systems 20 sense water they automatically open to drain swellwater to a flash tank 17 and automatically close when swellwater is no longer sensed to prevent the loss of steam. The system surge volume includes the drained superheater last two tube rows and headers 14, horizontal drain tubes 11, horizontal drain manifold 8 and a larger expansion volume in the start-up apparatus downstream of the loop barrier contained in the downward leg volume shown as: L=VOL of the steam discharge line to the pressure control valve 12 near ground level (see FIG. 3). This surge volume provides for HRSG pressure control, stability and damping during the starting method. As the gas turbine accelerates toward full synchronous speed no load and as gas temperature rapidly increases; the dryout zone locates farther upstream as swellwater as heated boilerwater and swellwater at saturation temperature drains from the last high pressure superheater row 2 into the next row of the superheater bundle at a controlled rate depending on the flow rate (FR setting for valve 16 from controller 100). Thereby heating the upstream tubes and reducing the differential row-to-row temperature and corresponding thermal stresses. Saturated Stream pressure is slowly increased by apparatus 1 pressure control valve 12 conducting steam through desuperheater DS 51 to the condenser, thereby slowly increasing saturation temperature, shrinking the swellwater steam bubbles and forcing most of the swellwater farther upstream into the superheater tube bundle; thereby reducing and then eliminating carryover swellwater into the horizontal manifold 8. This increases the area of dry tubes heat transfer area to rapidly generate dry superheated steam. Dry steam is generated and flows through the start apparatus 1, as superheat temperature is added at a controlled gradual rate to achieve the allowable 700° F. dry steam. The steam pressure and temperature increase as dry steam flow cools the tube rows 2 preventing over temperature and concurrently the steam flow is heating the thick wall headers 14 preventing high differential temperature stresses between thick headers and thin wall tubes. At dry steam generation event, the pressure control is transferred from the start-up apparatus 1 pressure control valve 12 to the pressure control bypass valves 46 and 35 conducting steam from the high pressure superheater header 14 through the reheater cold header to the hot reheater header 3 to the desuperheater DS 31 into the condenser, bypassing the steam turbine sections to control the high pressure and intermediate steam pressures. Importantly, the superheater tubes starting at flame detection function as a protective thermal evaporation screen, greatly lowering the temperature of exhaust gases into the reheater. As a result, the exhaust gases entering the reheater are hundreds of degrees less than in conventional HRSGs and additionally protect the reheater from overheating and thermal stress damage.

At the programed seven minutes to Full Speed No Load, or when high pressure steam flow is sensed at 700° F. by controller 100 set point switch 81 T_{HP}, the start-up boilerwater level controller 100 commands circuit drain valve 16 to close. This event also signals the feedwater flow rate controller 88 (see FIG. 6) to assume control of the high pressure steam temperature set point of 700° F. from the Steam Turbine Stress Controller (STSC) and maintain the set point temperature until the gas turbine is fully loaded. Steam temperature is controlled by calculating a high pressure feedwater flow rate W_{FWTOT} by controller 88. The controller modulates feedwater flow command of W_{FWTOT} to a feedwater flow control system 150 including: a Variable Frequency drive motor of the high pressure feedwater pump 4, and a feedwater control valve 15. The feedwater flow control system 150 integrates the pump flow performance curves matched to feedwater control valve 15 flow curves and the VF drive motor to provide the efficient control of feedwater to the HRSG. The turbine steam flow is initially all from the high pressure superheater header 14 and is conducted through the high pressure turbine admission valve 48 to the high pressure steam turbine HP section, and to the intermediate pressure steam turbine start-up-admission valve 49 to the IP steam turbine section. The flow split and steam flow rate to each section is controlled by the Steam Turbine Stress Controller for safe steam turbine warming in response to the steam turbine measured metal turbine component temperatures and other criteria to manipulate the steam turbine's SCV control valves. Valve 49 permits most initial steam flow at 700° F. be admitted to the IP steam turbine or flow can be split with the HP turbine. During this phase of starting; pressure control bypass valves 46, 35 and 12 allow steam not admitted to either turbine section to bypass the high pressure steam turbine and intermediate steam turbine while the turbine's admission and control valves 48, 49 and SCV valves are manipulated. Thereby providing an alternate steam flow path to the condenser through the reheater 3 to cool the reheater tubing in the HRSG starting and to also thereby control high and intermediate steam pressure levels. For single shaft gas turbine-steam turbine configurations some of the steam flow is connected to the low pressure steam turbine section LP to augment last stages bucket cooling steam flow from the auxiliary steam system. The reheater 3 hot header discharge steam enters the intermediate pressure manifold 7 and steam flows through the intermediate turbine bypass valve 35 through a desuperheater 31 to the condenser. In this initial phase of starting both the intermediate and high pressure steam turbine sections have steam flow at 700° F. from high pressure superheater header 14, the intermediate turbine IP is isolated from steam flow in the intermediate pressure manifold 7 by maintaining the normal intermediate pressure turbine admission valve 47 closed. This is necessary because hot header 3 discharge temperature is less than 700° F. due to reduced expanded steam exhaust temperature from the high pressure HP turbine combined with the reduced gas temperature flow into the reheater due to evaporation of boilerwater in the rows of the superheater tubing upstream of the reheater last row to hot discharge header 3. The steam from header 14 to the steam turbine sections is maintained at 700° F. by feedwater flow controller 88 by adjusting the dryout zone location in the high pressure superheater to continue warming the steam turbine until the gas turbine attains Full Speed No Load. Warming is regulated by the Steam Turbine Stress Controller manipulating SCV valves to control steam turbine components metal temperature, pressures and speed to minimize stresses. The systems bypass pressure control valves 46, 31 and 12 valves conduct steam to the condenser controlling high and intermediate steam pressures until the system is ready to be loaded to rated power.

At Full Speed No Load the gas turbine is loaded as fast as allowable to full load and the exhaust gas temperature ramps up to approximately 1100° F. in 15 to 20 minutes. As the gas temperature increases controller 88 maintains the high pressure steam increasing discharge flow at the low allowable starting temperature 700° F. by increasing high pressure feedwater flow (see next section). The Steam Turbine Stress Controller (STSC), using sensors in the steam turbine measuring metal temperatures, pressures and other parameters manipulates steam turbine stop control valves SCV to control starting rates of the intermediate pressure steam turbine IP section and the high pressure turbine HP section. Concurrently the high pressure turbine bypass valve 46 is modulated closed. At full gas turbine load total high pressure steam flow is approximately 120% rated flow due to the lower outlet temperature 700° F. being generated for starting the steam turbine. Steam flow rates may be adjusted to approximately 60% of rated turbine flows through the high pressure section admission valve 48 and intermediate pressure section start-up admission valve 49 (the flow splits depend upon specific steam turbine design). At full gas turbine load the steam turbine is loaded as fast as safely allowable to full rated power. The high pressure steam temperature is increased by the setpoints generated by the STSC to the feedwater controller 88. Reheater hot header 3 flow is from of the increasing exhaust temperature of the high pressure turbine HP. Additionally, the gas temperature flow from the high pressure superheater is also rapidly increasing the intermediate pressure steam temperature from reheater header 3 flow into manifold 7. As temperature increases to 700° F. in steam discharge from header 3 it is then conducted through the normal admission valve 47 and mixed with flow from the intermediate pressure turbine start-up admission valve 49. The high pressure superheater header 14 temperature setpoints are increased from 700° F. to load the steam turbine by adjusting the dryout zone in the superheater to corresponding increasing exhaust gas temperature by feedwater controller 88. Thereby at a safe rate established by the Steam Turbine Stress Controller the high pressure steam temperature setpoints to feedwater controller 88 are increased to full rated steam turbine temperature and flows at a rate and flow to the steam turbine at acceptable stresses and other parameters. At full gas turbine load; feedwater flow controller 88 adjusts the dryout zone position from the high pressure superheater to its normal position in the vaporizer 26. Thereby Full Load steam temperature of typically 50 F degrees less than the gas turbine's exhaust gas temperature can be obtained within approximately 20 to 50 minutes depending on the design of the steam turbine. This permits Intermediate steam turbine normal admission valve 47 to be controlled fully opened as intermediate steam turbine start-up valve 49 is synchronized closed when the steam turbine is fully loaded with the steam admission valves 48 and 47 fully opened and as the steam system pressure control bypass valves 31, 46 and 12 are manipulated to maintain steam pressures during loading of the steam turbine to full rated load by providing alternative flow paths. The STSC manipulates the steam turbine SCV control valves in loading the steam turbine to full power load without attemperators spraying cool boilerwater into hot superheater and reheater components. At full rated power steam valves to turbine are fully open and all bypass valves fully closed; and at the normal CC operating condition of the throttle pressure sliding up or down as HRSG steam generation varies in operation.

The dryout position is controlled by adjusting the total flow of feedwater W_{FWTOT} signal to regulate feedwater flow control system 150 that regulates feedwater valve 15 and high pressure feedwater pump 4 VFD motor to obtain the high pressure steam superheater temperature T_{HP} for the T_{SET POINT} calculated by the Steam Turbine Stress Controller. FIG. 6 illustrates schematically how feedwater flow controller 88 regulates the feedwater flow as it receives gas turbine 18 parameters: speed 90 N, exhaust gas temperature 96 T_{gas}, inlet guide vane position 95 IGVP and ambient air temperature 92 T_{AMBIENT}. The controller 88 enters this data into function generator 94 to calculate the weight of gas flow W_{gas} into the HRSG 25 as a key input to calculation block 118. The controller 88 calculates the amount of the gas turbine exhaust energy flowing into the HRSG and balances it with the output steam energy generated to determine the algorithm for the flow of feedwater, W_{FWTOTAL} into header economizer 5 of the HRSG 25, and the energy balance is approximated by:

W_{FW}·(C_{PFW}·ΔT_{FW}+h_{fg})=W_{gas}·C_{gas}·ΔT_{gas} (4)

Where:
C_{PFW}=the average specific heat of steam and water on the water side of the HRSG at the design point,
ΔT_{FW}=Tₛₑₜₚₒᵢₙₜ−Tᵢₙ=the increase in feedwater temperature into header 5 Tᵢₙ to steam outlet temperature, where Tₛₑₜₚₒᵢₙₜ is an input from the Steam Turbine Stress Controller,
h_{fg}=the latent heat of vaporization of water,
ΔT_{gas}=the change in temperature of the turbine exhaust gas in the HRSG,
W_{FW}=the mass flow of high pressure feedwater through the HRSG,
W_{gas}=the mass flow of hot gas supplied to the HRSG as calculated from measured operating parameters of the gas turbine, and
C_{gas}=the specific heat of the hot gases supplied to the HRSG.

Certain parameters were established to optimize the controller function. One is the temperature of gas discharging from the high pressure economizer tube rows as 280° F. Thus, ΔT_{gas}=T_{gas}−280° F., where T_{gas} is a measured parameter of the exhaust gas of the gas turbine. The specific heat of the gas and the water-steam are assigned average values of: C_{gas}=0.25 and C_{PFW}=0.68. The feedwater inlet temperature Tᵢₙ to the high pressure steam economizer at rated full gas turbine power is set at 240° F. from FW heater and low pressure steam generator evaporator. With the foregoing, the high pressure feedwater flow is as follows:

W_{FW}=W_{gas}·(T_{gas}−280° F.)·C_{gas}/C_{PFW}·(T_{HP set point}−240° F.)+h_{fg} (5)

The heat of vaporization is relatively constant and is replaced by an assigned value of h_{fg} of 950 btu/lb. As CP_{PFW} and Tᵢₙ are relatively constant and replaced as shown below. Thus, with all assigned values substituted, the high pressure feedwater flow control algorithm becomes;

W_{FW}=K·[0.25W_{gas}·(T_{gas}−280° F.)/0.68·(T_{HP setpoint}−240° F.)+950] (6)

Correction factor K reduces flow to correct for intermediate steam generator reductions in gas temperature and plus deviations of the assigned values causing errors in the predictive open loop algorithm. These error causing factors are corrected by the high gain closed loop temperature Proportional and Integral PI Controller 110 that corrects for calculation approximations and other factors.

In the closed loop mode of superheater control, a corrected feedwater flow rate and a Closed Loop Correction Factor (W_{CLCF}) are generated in accordance with the equations:

FW_{TOTAL}=W_{FW}+W_{CLCF} (7)

and,

W_{CLCF}=(T_{HP set point}−T_{HP})G_{CLCF} (8)
FW_{TOTAL}=the newly computed feedwater flow including the Closed Loop Correction Factor G_{CLCF} in: lb/hr/° F.
T_{HP}=the measured high pressure superheater outlet temperature, and
G_{CLCF}=The gain coefficient is assigned a value of 400 lb/hr/° F.

The steam output temperature T_{HP} is measured for example by thermocouple well and summed in adder 108 with T_{HP setpoint} from Steam Turbine Stress Controller (STSC). This produces an error signal which is converted by a conventional Proportional and Integral PI controller 110 to a control signal compatible with that generated by calculation block 118. The latter signal is summed with the predictive feedwater flow (W_{FW}) signal in adder 114, producing the corrected feedwater command signal (W_{FWTOTAL}) for a command signal to the feedwater system controller 150. Controller 150 is a PLC, a standard Programmable Logical Controller including Proportional and Integral PI Controller functions that integrate the systems to operate feedwater control valve 15 and the high pressure feedwater pump 4 VFD drive motor to optimize pumping efficiency into the HRSG 25. Feedwater system controller 150 also employs a closed loop PI feedback signal from the flow meter 50 downstream of valve 15 to correct the flow for leakage, wear and cavitation erosion of components.

Throughout the above starting method protecting the superheater from high thermal stress, the reheater is also started to minimize the reheater thermal starting stresses. The superheater functions as a protective evaporator heat transfer screen; greatly reducing the gas temperature entering the reheater tube rows immediately downstream of the final rows of the superheater. The reduced gas temperature is however sufficiently elevated to evaporate condensate which is uniformly distributed and accumulates at the bottom of each reheater U-tube after shutdown cooling. The flame detection signal is employed to connect the reheater to the vacuum in the condenser by opening intermediate steam turbine IP bypass valve 35. Thereby the condensate in the bottom portion of the numerous U-tube studs has relatively high area for being heated by hot exhaust gas above the boiling temperature at vacuum for seven minutes as the gas turbine is accelerating and thereby evaporating much of the condensate. Additionally, reheaters do not have bottom headers having relatively low gas flow surface area to evaporate pools of collected condensate as in conventional reheaters. As a consequence, small volumes of condensate in each tube, if remaining, with relatively high tube surface area when sprayed upward by steam flow and exposed to the high heating rate in the finned section, will rapidly evaporate without causing water slugging damage as steam flow is initiated. This minimizes the documented problematic draining and water slug quench damage history of reheaters in starting of conventional HRSGs. Also eliminated by this method is the thermal expansion stresses due to bottom headers and their rigidly connected drain piping restraint stresses.

The feedwater flow controller 88 described above for starting is also employed, as in operating to optimize CC performance in extremes of ambient air temperatures and, to reduce the high pressure steam temperature T_{HP} when the gas turbine is operated at low-load. At low-load in many gas turbines, gas flow W_{GAS} is reduced by inlet guide vanes 95 position to improve part load efficiency. A mass flow decrease causes the exhaust gas 90 T_{GAS} to increase, resulting in higher superheater and reheater steam temperatures. Tube metal temperatures may exceed design allowance due to reduced cooling and therefore steam temperature must be reduced to prevent damaging loss of component life. In conventional combined cycles the attemperators discussed earlier are used to cool the high pressure superheater and reheater steam temperature by spraying relatively cool boilerwater into relatively low steam flow interstage pipes risking overspray thermal shock. The problematic attemperator systems are replaced by controller 88 adjusting the dryout zone from the evaporator 26 into the superheater and thereby reducing the area of the superheater, resulting in lowing the high pressure superheated steam T_{HP} by locating the dryout zone into the superheater, the inlet gas temperature into the reheater also decreases causing the reheater discharge temperature to decrease from hot discharge header 3. Thereby replacing attemperators to cool the steam and protect the superheater and reheater tubes from damaging high temperatures or component thermal stresses.

The starting methods for the intermediate, low pressure steam generators and the low pressure turbine section are not described herein to better illustrate this disclosure's method, since they can be started with conventional methods or use the method described herein. Further, the use of an auxiliary boiler for: warm up, seal steam, deaeration steam, fuel heating, low pressure LP steam turbine cooling and other functions are not described since these elements use conventional methods.

A cold starting method after a long shutdown periods such as a weekend or maintenance is described. The HRSG is protected with nitrogen blanketing to prevent air ingress as steam pressure falls to near ambient air pressure. All steam spaces not filled with boilerwater over long shutdowns are blanketed with at least 5 psig nitrogen gas by a nitrogen line connection 27 to the horizontal drain manifold 8 (see FIG. 3). The same starting method is used as described in the warm starting method, except nitrogen replaces saturated steam as the initial motive pressure to drain the HRSG circuits. In this cold starting method, feedwater is pumped in to fill and compress the nitrogen gas space above the boilerwater in the HRSG, the gas is compressed by water flow from the feedwater pump 4 and nitrogen pressure increases severalfold depending on the internal volume of the superheater, evaporator and start-up apparatus 1. If less than 35 psig, pressure is increased to at least 35 psig by nitrogen line 27. The compressed nitrogen is the initial motive pressure to force drain and lower the boilerwater level into the position above the high pressure superheater header 14 in nozzle 9 to place the HRSG into a “ready to start status”. After sufficient steam pressure is generated during gas turbine acceleration, steam pressure takes over as the motive pressure to more rapidly drain the circuits through circuit drain control valve 16.

A hot starting method is described and is necessary for CC support of variable power sources such as solar and wind where weather can cause loss of power to the grid in minutes. If the CC is placed on dispatch service to support variable power, the hot starting method is the same as the warm starting method described above, except the high pressure superheater header 14 temperature is lowered to reduce cumulative loss of thermal stress fatigue life in starting. At the time of gas turbine shutdown, the superheater headers 14 may be hundreds of degrees above the saturated steam temperature of the boilerwater in the evaporator depending on the cool down time prior to shutdown. To minimize stresses in this condition, saturated steam flow through the header is initiated immediately after gas turbine spin-down to reduce header 14 temperature. Shutdown spin-down cooling will have caused the superheater tubes to be cooled to below saturated steam temperature and condensate forms in the bottom of each U-tubes. At shutdown, the final rows 2 of tubes may contain greater than 5% of the tube volume as saturated condensate at the bottom U-bends. The start-up apparatus 1 has a small bypass flow control valve 33 (FIG. 3) to meter low flow rates of steam. It is modulated to accurately manage lower steam flow rates than the large pressure control valve 12. Valve 33 bypasses saturated steam flow around valve 12 to the condenser to cool the headers 14 to approach saturation steam temperature. Valve 33 controls the rate flow around valve 12 to prevent condensate carryover of large droplets from condensate in the superheater tube bottoms. Flow rate is maintained sufficiently low to prevent liquid slug carryover quenching damage to headers 14. At low flow rates, gravity separation allows only a fine mist to exit the long vertical tubes. As the condensate water is evaporated, saturated steam flows at hundreds of degrees below the header temperature, cooling the headers and the header metal approaches saturation temperature. When a typical header 14 discharge steam temperature sensor 32 T1 (see FIG. 2) in drain pipe 11 indicates the header temperatures are adequately lowered from the header, and valve 33 is closed to conserve energy for the next start.

While the apparatus and method have been described in connection with a certain embodiment related to the most serious problems now afflicting fast starting HRSGs and is considered the most practical and preferred embodiment, it is to be understood that the invention is not limited to the disclosed embodiment. On the contrary, it is intended to cover various modifications such as: temperature levels, pressure levels, wherein components of each system and methods may be independently utilized. The described embodiment is also intended to cover various other combined cycle systems such as: supercritical steam HRSGs such as described in U.S. Pat. No. 7,874,162 SUPERCRITICAL STEAM COMBINED CYCLE AND METHODS and other HRSGs with fewer steam pressure levels, horizontal tube HRSGs with once-through circuits, intermediate and low pressure sections of once-through HRSGs, supplementary fired HRSGs and equivalent arrangements included within the spirit and scope of the invention by one of ordinary skill in the art to the appended claims.

1-10. (canceled)

11. A method for fast starting a combined cycle power generating system including an improved heat recovery steam generator system, HRSG, that complements the latest fast starting state-of-art-gas turbines that start to full load in 30 minutes or less, said method comprising: loading a gas turbine up to a rate that is approximately equal to the maximum loading rate of the gas turbine; said improved HRSG generates steam at a temperature for the initial allowable flow to a steam turbine as the gas turbine reaches full speed no load typically in about 7 minutes, and as the gas turbine starts to load and maintain a temperature of steam supplied to the steam turbine at a substantially constant allowable temperature from initial steam admission into the steam turbine until all the steam generated from said HRSG from the exhaust flow of the gas turbine operating up to maximum load is admitted into the steam turbine at allowable temperatures and flow rates to limit steam turbine stresses and control clearances and rapidly load the steam turbine to full power steam temperature without conventional attemperators cooling the steam and thereby eliminating their problematic cold boilerwater spray injection cooling systems to prevent overtemperature steam and components when starting the steam turbine; whereby said innovative starting method, starting with a wet superheater full of boilerwater, reduces thermal fatigue stress crack failures of HRSG components and possible steam turbine boilerwater ingestion damage in fast starting; thereby increasing availability and reducing maintenance costs of power plants.

12. A method for fast starting a warm, greater than 280° F. HRSG of the combined cycle in accordance with claim 11, wherein said improved HRSG system further includes inventive elements and tasks to reduce start-up time and superheater and reheater stresses including the following:
element 1; Said improved HRSG system is configured with a once-through circuit flow path in at least all high pressure circuits;
task I; said high pressure circuits started wet to minimize thermal stress, innovatively filled with boilerwater prior to starting by a start-up apparatus that positions boilerwater in each superheater to the same level, said improved HRSG is configured to synchronize with fast starting large state-of-the-art gas turbine that are started at a maximum rate to full power in approximately 30 minutes, or less, wherein the gas turbine typically accelerates to Full Speed No Load in approximately 7 minutes and said inventive starting method replaces the state-of-the-art method of starting the high pressure superheater dry, containing static steam or nitrogen, whereby initial steam flow from the downstream high pressure evaporator is delayed for many minutes, thereby causing dry superheater tubes to quickly approach the exhaust gas temperature even though their headers remain near starting temperatures; said innovative wet start prevents the rapid rise of superheater tubes to gas temperature;
task 2; saturation pressure is controlled as the gas turbine accelerates, said last row of superheater tubes containing boiling water maintained at saturation pressure-temperature controlled by an inventive start-up apparatus with a pressure control valve to gradually control increasing steam pressure and corresponding saturation temperature of swellwater and steam flowing through said last row tube joints to headers, uniformly heating them at low saturation temperature by means of water-steam mixture thereby reducing critical joint stresses as tube temperature is gradually controlled by saturation pressure controlling the steam temperature;
element 2: concurrently, initiated by the flame detection signal, an innovative start-up boilerwater level controller calculates the flow ratio opening for an innovative circuit drain valve to open and adjust its flow ratio opening to the actual motivating saturation pressure starting warm or hot, thereby to control draining a specific volume of boilerwater in 7 minutes at a specific drain rate from said last rows of high pressure superheater, thereby controlling the dryout zone position in said last row of superheater tubes to control increasing dry steam temperature to generate the allowable starting superheat temperature in 7 minutes or less; thereby the boilerwater level is positioned into the top of the second row of tubes in the superheater for all measured starting pressures, as the gas turbine accelerates to Full Speed No Load;
task 3; said circuit drain system valve connects each circuit's first row economizer tubes to a circuit drain header controlled by a circuit drain valve discharging to a flash tank, the dryout zone is thereby hydraulically locked and controlled by said circuit drain system and concurrently a portion of swellwater is controlled to flowing upstream in each circuit by sad boilerwater level controller manipulating said circuit drain valve conducting boilerwater draining through said first row economizer tubes, thereby drain flowing toward the economizer from said last rows of high pressure superheater is warming adjacent downstream superheater tube rows, reducing differential thermal stress between rows as the dryout zone level is controlled to be located farther upstream from said high pressure header increasing said dry tube wall area, thereby controlling superheat steam temperature as boilerwater level controller is manipulating said circuit drain valve, and maintains the allowable steam temperature at 700° F., in this gas turbine; as the gas turbine accelerates to Full Speed No Load, at 700° F., or in the scheduled seven minutes;
task. 3; said circuit drain valve is closed and steam temperature control is transferred to a high pressure feedwater flow rate controller that balances steam flow energy to gas turbine exhaust energy; to maintain the allowable steam temperature at 700° F. as the gas turbine is fully loaded as fast as permissible in approximately 23 minutes for gas turbines with total 30 minutes fast loading time including 7 minutes to Full Speed No Load; and by said feedwater controller increasing high pressure feedwater flow maintains the allowable temperature at 700° F., and at gas turbine Full Load the steam temperature is raised to full load steam turbine rated temperature and flow as fast as permissible by said feedwater flow rate controller at a rate responding to increasing steam temperature setpoint signals transmitted from the Steam Turbine Stress Controller that is also measuring steam turbine parameters to manipulate steam flow and pressure to the steam turbine admission, control valves and bypass valves to control high pressure and intermediate pressure steam turbine sections to satisfy the steam turbine criteria for steam turbine metal temperature matching, limiting stresses and maintain clearances as the steam turbine is loaded, and said high pressure feedwater flow rate controller is adjusting high pressure feedwater flow to locating the dryout zone into normal full load steam temperature position in the evaporator tube bundle section.

13. A method in accordance with claim 12 said improved HRSG further comprising the following elements and tasks:
element. 1: a high pressure superheater tube bundle arranged so said last rows of tubes in the final superheater bundle are at the exhaust gas entrance into said improved HRSG; and a hot discharge row of the reheater tube bundle dispersed downstream from said last superheater rows are arranged to receive cooled exhaust gas flowing from said high pressure superheater entering said reheater to protect it from over temperature in said wet starting method;
element 2; and said improved steam generating system: further includes a plurality of steam turbine admission paths and admission valves to the steam turbine stop and control valve elements, and a plurality of bypass paths from said heat recovery steam generator to the condenser;
task. 1; said method further comprises controlling the flow of steam and pressures In and through said bypass paths and conducting an innovative cooling steam flow through said reheater to cool said reheater in starting; using a portion of the flow from the wet superheater generating low allowable steam temperature used in also starting the steam turbine and thereby controlling the high pressure and intermediate steam pressure from said heat recovery steam generator as steam is bypassed and conducted to the condenser;
task 2; and further, said systems includes an inventive bypass path conducting steam from said high pressure superheater, bypassing the high pressure section of the steam turbine to connect high pressure steam flow directly to the intermediate pressure steam turbine section by moons of an innovative intermediate steam turbine start-up admission valve controlling the high pressure steam flow split from said high pressure superheater in any flow split proportion between either the intermediate steam turbine section or the high pressure steam turbine section; thereby high pressure steam flow split is regulated by said intermediate steam turbine start-up admission valve to sustain an allowable steam temperature and flow synchronized by temperature set points to said high pressure feedwater flowrate controller and steam control valves manipulated from the steam turbine's starting control element; the Steam Turbine Stress Controller.

14. A method In accordance with claim 12, wherein improved HRSG and method further includes inventive elements and tasks;
element 1; said inventive start-up apparatus fabricated from a pipe weldment with a single level sensor element and a horizontal drain manifold that includes at least a pot drain valve at each end, said horizontal drain manifold geometrically arranged to fill and vent each said last row of superheater tubes to identical start-up levels to facilitate boilerwater level control in starting;
task 1; prior to starting said improved HRSG system: feedwater is pumped into the high pressure economizer headers and equally distributed to each circuit by an orifice in each said first row economizer tubes, completely filling each high pressure circuit with boilerwater through said last row of superheater tubes, and said start sequence signals said pot drain valves in said horizontal drain manifold to remain closed, thereby permitting water flow to continue filling said horizontal drain manifold to said level sensor element which stops the flow above said horizontal drain manifold located several feet above each high pressure header and from this level water draining down by gravity automatically filling each said last row high pressure superheater tubes, filling them and venting steam, or nitrogen if cold, by gravity flow as steam or gas is vented into space above said level sensor;
task 2; thereupon said start-up apparatus functions by a control signal to adjust the boilerwater level into the “ready to start status” whereby said pot drain valves are signaled to function normally and open when detecting water and thereby they completely drain said horizontal drain manifold system and automatically close to conserve thermal energy, thereby lowering the boilerwater level to the middle of each header nozzle directly above each said last row tubes and headers by the geometric arrangement of said pipes, thereby starting can be initiated at any time with a known volume of water and pressure in each of the once-through high pressure superheater tubes; and wherein each circuit's said last row superheater tubes are connected to and hydraulically locked to said circuit drain system through their the first row economizer tubes;
element 2; in addition; said start-up apparatus is also configured to remove swellwater generated during starting by said start-up apparatus said horizontal drain manifold's pot drain valve system configuration, said start-up apparatus is also configured with a pressure control valve to regulate high pressure saturated steam pressure in starting and nitrogen pressure connection for cold starting the horizontal drain manifold;
element. 3; and further, said start-up apparatus is configured external to the casing to improve maintenance and is not connected in the steam flow path during normal power operation and thereby does not reduce rated combined cycle performance by parasitic steam flow pressure loss.

15. A method in accordance with claim 12 in starting said heat recovery steam generator to evaporate condensate from said reheater accumulated from past operations of spin-down and fuel gas purge cooling, said method including the following element and task:
element 1; said reheater tubes configured without bottom headers preventing large pockets of condensate pooling in the header and thereby dividing condensate Into small quantities in the bottom of U-bends;
task 1; wherein at the flame detection signal, said bypass path from said reheater is connected to the condenser vacuum, reducing the pressure in said reheater; thereby increasing the rate of evaporating condensate in the bottom of each reheater tube by the hot exhaust gas flowing across the relatively high heat transfer area of the hundreds U-tube stubs during the time period the gas turbine accelerates to Full Speed No Load, whereby most of the small volumes of condensate evaporates from the bottom of said U-tubes or evaporates in the upward vertical flow path through the long vertical tube path; eliminating quench damage to hot discharge reheater headers when dry steam flow is connected to cool said reheater in starting sequence.

16. A method in accordance with claim 12 starting wherein said heat recovery steam generator is hot, typically when tripped from high power or shut down rapidly for operational problems; and thereby said superheater headers are near full load operating temperature, and may be hotter by hundreds of degrees than the saturated boilerwater condensate contained at the bottom of each said superheater tube or in the evaporator tubes after spin down cooling; and if said combined cycle power plant is placed on immediate standby dispatch duty requiring boilerwater to be pumped into said startup apparatus to obtain “a ready to start status”; said method comprising the following elements and tasks;
element 1; said start-up apparatus configured with a bypass metering valve conducting steam around said start-up apparatus pressure control valve to the condenser;
task 1; whereby modulating said metering valve is controlling saturated steam flowing through and cooling said superheater headers at a controlled low flow velocity; limiting carry-over of condensed boilerwater and preventing quench damage to said high pressure headers as saturated steam flow cools said headers;
element 2; and a steam temperature sensor downstream of a typical said superheater header is located to measure steam flow temperature through said header;
task 2; and when said high pressure superheater headers are cooled adequately to enable a warm starting; thereby said metering bypass valve is closed to conserve thermal energy; and said hot combined cycle power plant system is placed into: said “ready to start status” in accordance with said warm heat recovery steam starting method of claim 12.

17. A method for starting a cold combined cycle power plant system in accordance with claim 12, wherein said heat recovery steam generator is cold, less than 280° F. at a steam saturation pressure less than 35 psig, comprising the following task:
task 1; nitrogen gas is conducted to said start-up apparatus through a nitrogen connection valve; displacing steam as it is condensing to maintain internal pressure sufficiently high, greater than 5 psig, to prevent corrosive air leakage into said HRSG, but at a sufficiently high pressure, to be at least 35 psig following feedwater pumped flow in accordance with claim 14 into the superheater compressing nitrogen in said horizontal drain manifold to place said HRSG into “a ready to start status”.
